(19) United States
(12) Patent Application Publication
(10) Pub. No.: US 2021/0328485 A1
(43) Pub. Date: Oct. 21, 2021

(54) A STATOR AND A METHOD FOR ASSEMBLING A STATOR

(71) Applicant: Rolls-Royce Deutschland Ltd & Co KG, Blankenfelde-Mahlow (DE)

(72) Inventors: Gergely György Balazs, Budapest (HU); Janos Dorogi, Halásztelek (HU); Zoltan Nadudvari, Pálosvörösmart (HU); Daniel Kutrovich, Pomáz (HU)

(21) Appl. No.: 17/271,072

(22) PCT Filed: Sep. 10, 2019
(86) PCT No.: PCT/EP2019/074064

§ 371 Date: Feb. 24, 2021

(30) Foreign Application Priority Data
Sep. 27, 2018 (EP) 18197169.8

(51) Int. Cl. H02K 15/04; H02K 1/14; H02K 1/17; H02K 3/18; H02K 3/52; H02K 21/04; B64D 27/24

(52) U.S. Cl. CPC H02K 15/045; H02K 1/146; H02K 1/17; B64D 27/24; H02K 3/522; H02K 21/042; H02K 3/18

(57) ABSTRACT

A stator is provided for a permanent magnet synchronous motor. The stator includes a multiplicity of stator teeth, each stator tooth having a tooth axis. The stator further includes a stator ring with a stator axis, wherein the multiplicity of stator teeth is arranged radially along the circumference of the stator ring, and the tooth axes cross the stator axis orthogonally within one plane. The stator further includes a multiplicity of stator coils, each stator coil having a coil axis and a coil opening and including windings made of a wire, which windings extend along the coil axis, and the coil axis of the respective stator coil is arranged parallel to the tooth axis of the respective stator tooth and the coil opening of the respective stator coil surrounds the respective stator tooth, wherein the wire of the respective coil has a rectangular cross section with a shorter side and a longer side and the shorter side of the wire of the respective coil is orientated parallel to the coil axis of the respective stator coil.

The present patent document is a § 371 nationalization of PCT Application Serial No. PCT/EP2019/074064, filed Sep. 10, 2019, designating the United States, which is hereby incorporated by reference, and this patent document also claims the benefit of European Patent Application No. 18197169.8, filed Sep. 27, 2018, which is also hereby incorporated by reference.

### TECHNICAL FIELD

The disclosure relates to a stator for a permanent magnet synchronous motor, including a multiplicity of stator teeth, wherein each stator tooth of the multiplicity of stator teeth has a tooth axis and a stator ring, with a stator axis, wherein the multiplicity of stator teeth is arranged radially along the circumference of the stator ring, and the tooth axes cross the stator axis orthogonally within one plane, and a multiplicity of stator coils, wherein each stator coil of the multiplicity of stator coils has a coil axis and a coil opening and includes windings made of a wire, which windings extend along the coil axis, and the coil axis of the respective stator coil is arranged parallel to the tooth axis of the respective stator tooth and the coil opening of the respective stator coil surrounds the respective stator tooth.

Moreover, the disclosure relates to a method for assembling a stator for a permanent magnet synchronous motor.

### BACKGROUND

Prior art stators for permanent magnet synchronous machines often have stator coils, which are machined, e.g., winded directly around single-part stator teeth, which are subsequently assembled radially around a stator axis to achieve a final stator configuration. This procedure may allow for a flexible and simple design of the coils.

However, such stators may have limited fill factors at the stator coil or a low heat transfer between the individual turns of the windings of the stator coil or to the stator coil itself. Hence, the mechanical and electrical performance of the prior art synchronous machines is limited disadvantageously, especially at high operating frequencies.

### SUMMARY AND DESCRIPTION

The disclosure has its object to provide an improved stator and a method for producing an improved stator to overcome the disadvantages of prior art stators and subsequently to allow a performance improvement of the stator.

The scope of the present disclosure is defined solely by the appended claims and is not affected to any degree by the statements within this summary. The present embodiments may obviate one or more of the drawbacks or limitations in the related art.

This object is achieved according to a first aspect with a stator of the aforesaid type, wherein the wire of the respective coil has a rectangular cross section with a shorter side and a longer side, and the shorter side of the wire of the respective coil is orientated parallel to the coil axis of the respective stator coil. The longer side has a larger dimension than the shorter side.

In this matter, using a rectangular profile wire for a stator coil leads into a higher slot fill factor. Consequently, the heat transfer between the individual turns of the windings or to the respective stator tooth may be improved. However, in case of high operating frequency the resistance may be increased due to the skin effect. The resistance increment may be reduced by winding the rectangular wires in such a way, that the shorter side of the wire is parallel with the tooth axis.

Thus, the losses of the resulting magnets may be lower and a permanent magnet synchronous machine may have a higher torque and a higher power density.

The solution provides a simple winding procedure, because the teeth may be wound one-by-one before the assembly of the complete stator unit. The wire of the stator coil may have a cross section, which is large enough that the manufactured coil is mechanically stable enough for a further handling without a specific wire carrier for the wound stator coil at the subsequent assembly of a stator tooth and a stator coil. This mentioned stability may be achieved, if the cross section of the wire is more than 0.5 mm², more than 1 mm², or more than 1.5 mm². This aspect supports stator configurations for high current applications for high torque machines and/or machines at high operating frequencies.

Moreover, it is beneficial, if the respective stator tooth has a tooth width, which is defined by the dimension of the cross section in the direction orthogonal to the tooth axis and in a plane orthogonal to the stator axis, and the longer side of the wire is slightly smaller than the half of the tooth width. In particular, the respective cross section of the stator tooth is defined within the portion of the stator tooth, where the stator coil is to be mounted. This leads to a small bending radius of the wire at the windings, which enclose the respective stator tooth and simplifies herewith the production of the stator coil.

Consequently, enameled wires cannot be used in some cases as the small bending radius may damage the insulation of the wires. Therefore, it is advantageously if the turns of the windings are insulated from each other after the winding procedure, for instance by spraying up or immersion of an enamel finish.

In an additional aspect, the stator ring includes an outer side, directed radially outwards, on which the multiplicity of stator teeth is arranged. This enables a simple construction of a first stator type, especially in combination with the aforesaid features.

It is further beneficial in this aspect, if the stator further includes a multiplicity of yoke segments, wherein each yoke segment of the multiplicity of yoke segments is configured to be mounted between two respective adjacent stator teeth to connect the two respective adjacent stator teeth. This aspect leads to a closed slot stator configuration, which provides higher electrical performance versus an open slot stator, which has mostly a higher flux leakage and therefore reduces the overall efficiency of the electrical machine.

It is beneficial for a simpler manufacturing of parts of the stator if the multiplicity of stator teeth and the stator ring constitute a one-piece part. The separate manufacturing of the stator teeth and the stator coils allows a very simple production of the stator coil as well as a simple assembly of the stator.

For an improved assembly of the stator, the multiplicity of yoke segments and the multiplicity of stator teeth may constitute the stator ring. A mounting apparatus or device for holding the aforesaid parts together, (e.g., an additional ring), is not shown in the figures.

In a further additional aspect, the stator ring includes an inner side, directed radially inwards, on which the multiplicity of stator teeth is arranged. This enables a simple construction of a second stator type, especially in combination with the aforesaid features.

It is beneficial, if the stator ring includes a multiplicity of notches, each notch of the multiplicity of notches is configured to receive a mounting portion of the respective stator tooth. This aspect leads to a simple way of assembling removeable stator parts.

Here, it is beneficial, if each notch has a longitudinal elongation, which is orientated parallel to the stator axis and has laterally, e.g., perpendicularly to the stator axis a V-shaped opening, which is configured to receive a complementary shaped mounting portion of the respective stator tooth. The shape enables an easy assembling process; thus, a V-shape may be provided because a slip-in movement of the stator tooth into a respective notch at the stator ring supports the aimed easy assembling process and allows higher tolerances for the opening and the complementary shaped mounting portion as well as a simple and reliable final, but optionally releasable fixation of both parts.

It has advantages if the stator is arranged within a permanent magnet synchronous motor.

Moreover, it has advantages, if the stator is arranged within or as an electric propulsion system of an aircraft, which may require stator configurations for high current applications for high torque machines and/or machines at high operating frequencies and an overall light weight of the motor.

The problem is also solved by a method for assembling a stator. The method includes, in act a), providing a stator, including following parts: a multiplicity of stator teeth, wherein each stator tooth of the multiplicity of stator teeth has a tooth axis, and a stator ring with a stator axis, wherein the multiplicity of stator teeth is arranged radially along the circumference of the stator ring, and the tooth axes cross the stator axis orthogonally within one plane.

The method further includes, in act b), providing a multiplicity of stator coils separately from the multiplicity of stator teeth, wherein each stator coil of the multiplicity of stator coils has a coil axis and a coil opening and includes windings made of a wire, which windings extend along the coil axis, and the wire of the respective coil has a rectangular cross section with a shorter side and a longer side, and the shorter side of the wire of the respective coil is orientated parallel to the coil axis of the respective stator coil

The method further includes, in act c), placing each stator coil on the respective stator tooth, wherein the coil axis of the respective stator coil is arranged parallel to the tooth axis of the respective stator tooth and the coil opening of the respective stator coil surrounds the respective stator tooth.

The method further includes, in act d), assembling the multiplicity of stator teeth, each carrying a respective stator coil, together with the stator ring, if applicable.

The method may be carried out by performing the sequence of the acts a), b), c), and d). Alternatively, the acts a) and b) or acts c) and d) nay also being swapped if the respective stator configuration allows it.

Act d) is only applicable, if the stator ring and the stator teeth are manufactured as separate components, which need to be assembled together. However, in the case that the stator ring and the stator teeth are a one-piece part, act d) is obsolete.

Each stator tooth has a first end and a second end. In an assembled configuration of a stator tooth with the stator ring, the first end is joined with the stator ring and the second end is facing radially orientated opposite to the first end. With other words, the first end and the second end are oriented along the respective stator tooth axis.

With an improvement of the method, an insulation layer is provided at least partially on the surface the wire of the respective coil between act b) and c).

The method allows the use of pre-wound windings as stator coils, which leads to a simpler winding procedure of the stator coils because the coils may be wound separate from the stator tooth. In addition, the assembly of the stator is much simpler compared to prior art because pre-processed parts just need to be put together.

As mention before, it is beneficial if the longer side of the wire is slightly smaller than the half of the stator tooth width, because it leads to a small bending radius of the wire at the windings, which enclose the respective stator tooth. However, enameled wires cannot be used as the small bending radius may damage the insulation of the wires. Therefore, after the winding procedure the turns of the windings may be insulated from each other by the insulation layer, and subsequently the windings may be placed on to the teeth.

In a first further development, the multiplicity of stator teeth may constitute one piece together with the stator ring.

For the matter of the first further development, the method includes (subsequently to the acts a), b), c), and d)), in act e1), providing a multiplicity of yoke segments, wherein each yoke segment of the multiplicity of yoke segments is configured to be mounted between two respective adjacent stator teeth to connect the two respective adjacent stator teeth. The method further includes, in act f1), mounting the yoke segments between two respective adjacent stator teeth.

The method of the first further development may be carried out by performing the sequence of the acts a), b), c), d), e1), and f1). Alternatively, the acts a) and b) or acts c) and d) may also being swapped.

Here, it is beneficial, if the stator ring includes an outer side, directed radially outwards, on which the multiplicity of stator teeth is arranged. This enables a simple construction of a first stator type, especially in combination with the aforesaid features.

In this context, the second end of the respective stator tooth is facing radially outwards. The yoke segments may connect the respective second ends of adjacent stator teeth.

In a second, alternative further development, the stator ring includes a multiplicity of notches each configured to receive a respective stator tooth and, in certain examples, each of the multiplicity of notches may have a longitudinal elongation, which is orientated parallel to the stator axis and has laterally a V-shaped opening, which is configured to receive a complementary shaped mounting portion of the respective stator tooth.

For the matter of the second further development, after act d), the method further includes act e2): slide the stator tooth with the stator coil into the notches.

The method of the second further development may be carried out by performing the sequence of the acts a), b), c), and d), wherein act e2) is a succeeding part of act d). Alternatively, the acts a) and b) or acts c) and d) may also being swapped.

Here it is also beneficial, if the stator ring includes an inner side, directed radially inwards, on which the multiplicity of stator teeth is arranged. This enables a simple construction of a second stator type, especially in combination with the aforesaid features.

### BRIEF DESCRIPTION OF THE DRAWINGS

The disclosure shall now be explained based on exemplary embodiments thereof with reference to the accompanying drawings in more detail below.

FIG. 1 depicts a perspective view of an example of a stator coil.

FIG. 2a depicts a side view of a stator according a first embodiment with a cutting plane A-A.

FIG. 2b depicts a front view of the stator in the cutting plane A-A of FIG. 2a.

FIG. 2c depicts a perspective view of the stator of FIG. 2a.

FIG. 3a depicts a side view of a stator according a second embodiment with a cutting plane B-B.

FIG. 3b depicts a front view of the stator in the cutting plane B-B of FIG. 3a.

FIG. 4 depicts a perspective view of a yoke segment of the stator of FIG. 2a.

FIG. 5 depicts a perspective view of stator parts of the stator of FIG. 2a.

FIG. 6a depicts a side view of a stator according a third embodiment with a cutting plane C-C.

FIG. 6b depicts a front view of the stator in the cutting plane C-C of FIG. 6a.

FIG. 6c depicts a perspective view of the stator of FIG. 6a.

FIG. 7 depicts a perspective view of a stator tooth of the stator of FIG. 6a.

FIG. 8 depicts a perspective view of a stator ring of the stator of FIG. 6a.

### DETAILED DESCRIPTION

It is clear, that further not shown parts are necessary for the assembly and operation of a stator within an electrical drive, e.g., mounting parts, an electrical connection to a power supply and electronic control components. For the sake of better understanding these parts are not illustrated and explained in the following description.

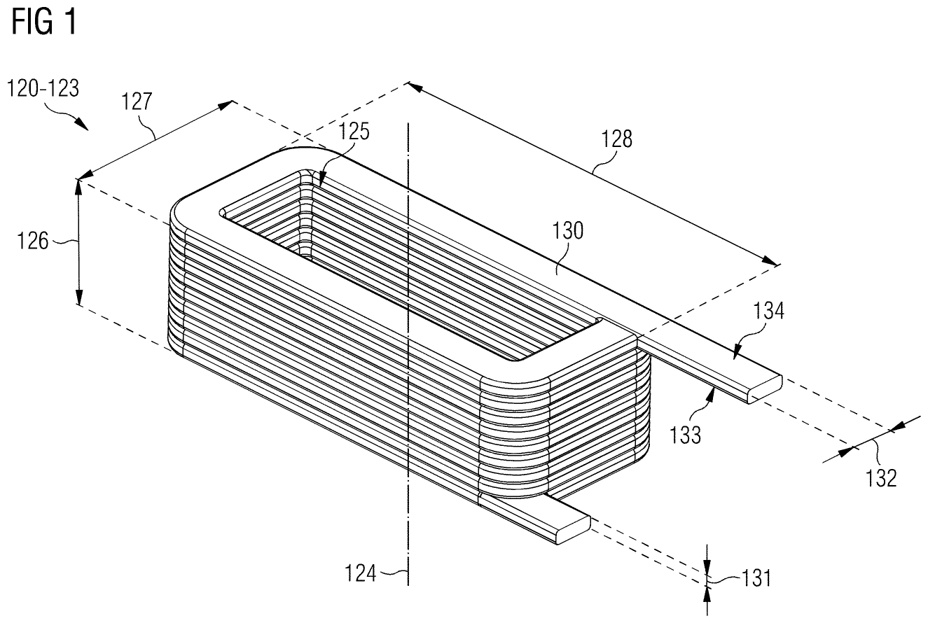

FIG. 1 shows a stator coil 120-123 for three embodiments of stators 100, 200, and 300, which stator coil 120-123 has a coil axis 124 and a coil opening 125.

The stator coil 120-123 includes windings made of a wire 130. The windings extend along the coil axis 124.

The coil axis 124 of the respective stator coil 120-123 is designed to be arranged parallel to a tooth axis of a stator tooth and the coil opening 125 is designed to surround a stator tooth.

The illustrated stator coil 120-123 illustrates the principle of the arrangement. The windings are shown only for a basic understanding and may have some inaccuracies in the representation. Moreover, the winding may have other configurations of the input and output ports as shown.

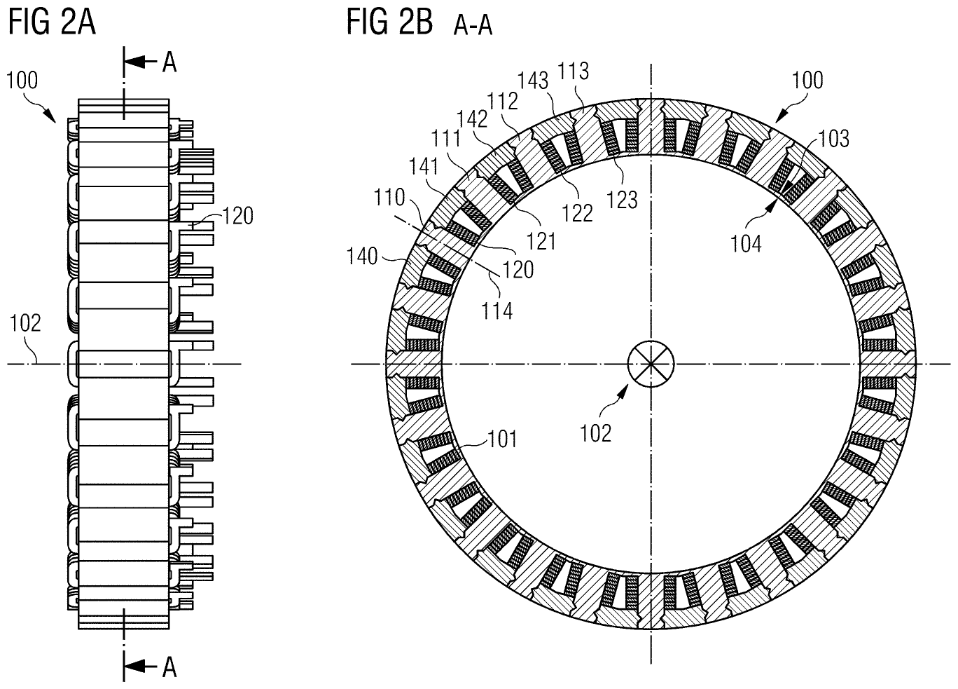

FIGS. 2a to 2c show a first embodiment of a stator 100 for a permanent magnet synchronous motor. A rotor with permanent magnets for a motor is not shown. The stator is designed to receive a permanent magnet rotor.

The stator 100 includes a multiplicity of stator teeth, wherein each stator tooth 110-113 of the multiplicity of stator teeth has a tooth axis 114.

The stator 100 further includes a stator ring 101 with a stator axis 102, which is the rotational axis of a final motor assembly, and wherein the multiplicity of stator teeth is arranged radially along the circumference of the stator ring 101. The tooth axes 114 cross the stator axis 102 orthogonally within one plane.

Moreover, the stator 100 includes a multiplicity of stator coils, wherein each stator coil 120-123 of the multiplicity of stator coils has a coil axis 124 and a coil opening 125. Each stator coil 120-123 includes windings made of a wire 130, which windings extend along the coil axis 124.

Each stator tooth 110-113 has a first end and a second end.

The coil axis 124 of the respective stator coil 120-123 is arranged parallel to the tooth axis 114 of the respective stator tooth 110-113.

Basically, for other not shown specific embodiments, the tooth axis may also have an angle with respect to the coil axis, e.g., below 10 or below 5°.

In the shown embodiment, the stator tooth 110-113 has a portion of the tooth body, which is designed to be inserted into the coil opening.

The stator tooth 110-113 has a body with a rectangular shape in its cross section, and the tooth axis 114 is in its center.

The tooth axis may also go through any other portion of the tooth, which is not shown in the embodiments. The same applies to the stator coil, e.g., the coil opening.

The coil opening 125 of the respective stator coil 120-123 surrounds the respective stator tooth 110-113.

The wire 130 of the respective coil 120-123 has a rectangular cross section with a shorter side 133 and a longer side 134, and the shorter side 133 of the wire 130 of the respective coil 120-123 is orientated parallel to the coil axis 124 of the respective stator coil 120-123.

It is clear, if the wire 130 has a rectangular cross section, it means in practice the edges of the wire have a small radius due to manufacturing issues. Of course, the wire 130 has an insulating coating for electrically separating the respective windings from each other. This aspect is not shown in the figures.

The stator ring 101 includes an outer side 103, directed radially outwards, on which the multiplicity of stator teeth is arranged.

The stator 100 includes a multiplicity of yoke segments, wherein each yoke segment 140-143 of the multiplicity of yoke segments is configured to be mounted between two respective adjacent stator teeth 110-113 for connecting the two respective adjacent stator teeth 110-113.

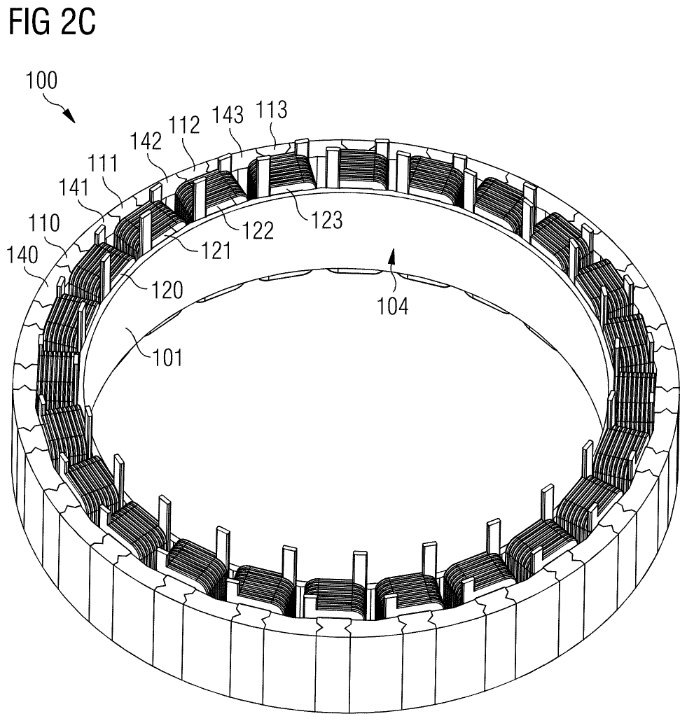

FIGS. 3a and 3b show a second embodiment of a stator 200, which is configured to receive a complementary permanent magnet rotor.

The stator 200 includes a multiplicity of stator teeth, wherein each stator tooth 210-213 of the multiplicity of stator teeth has a tooth axis 214.

The stator 200 further includes a stator ring 201 with a stator axis 202, which is the rotational axis of a final motor assembly, and wherein the multiplicity of stator teeth is arranged radially along the circumference of the stator ring 201. The tooth axes 214 cross the stator axis 202 orthogonally within one plane.

The multiplicity of yoke segments and the multiplicity of stator teeth constitute together the stator ring 201. A mounting apparatus or device for holding the aforesaid parts together, (e.g., an additional ring), is not shown.

Moreover, the stator 200 includes a multiplicity of stator coils, wherein each stator coil 120-123 of the multiplicity of stator coils has a coil axis 124 and a coil opening 125, as shown in FIG. 1, wherein the related description of a stator coil 120-123 also applies.

Each stator tooth 210-213 has a first end and a second end, which are opposite to each other regarding the tooth axis 214. The first end of a stator tooth 210-213 is oriented inwards the assembled stator 200 and includes a stator head, which has a widening of the cross section 215 of the stator tooth 210-213 for fixing a stator coil 120-123 during assembly. The second end of the stator tooth 210-213 has a mounting portion, e.g. a pair of notches, which hare configured to receive corresponding counterparts mounted on yoke segments. The portions of the pair of notches and the corresponding yoke segments may be assembled and fixed together e.g. by glue or screws in combination with an additional ring structure as a mounting apparatus or device.

The coil axis 124 of the respective stator coil 120-123 is arranged parallel to the tooth axis 114 of the respective stator tooth 210-213.

The stator tooth 210-213 has a body with a rectangular shape in its cross section, and the tooth axis 114 is in its center.

The coil opening 125 of the respective stator coil 120-123 surrounds the respective stator tooth 210-213.

The stator ring 201 includes an outer side 203, directed radially outwards, on which the multiplicity of stator teeth is arranged.

The stator 200 includes a multiplicity of yoke segments, wherein each yoke segment 140-143 of the multiplicity of yoke segments is configured to be mounted between two respective adjacent stator teeth 210-213 for connecting the two respective adjacent stator teeth 210-213.

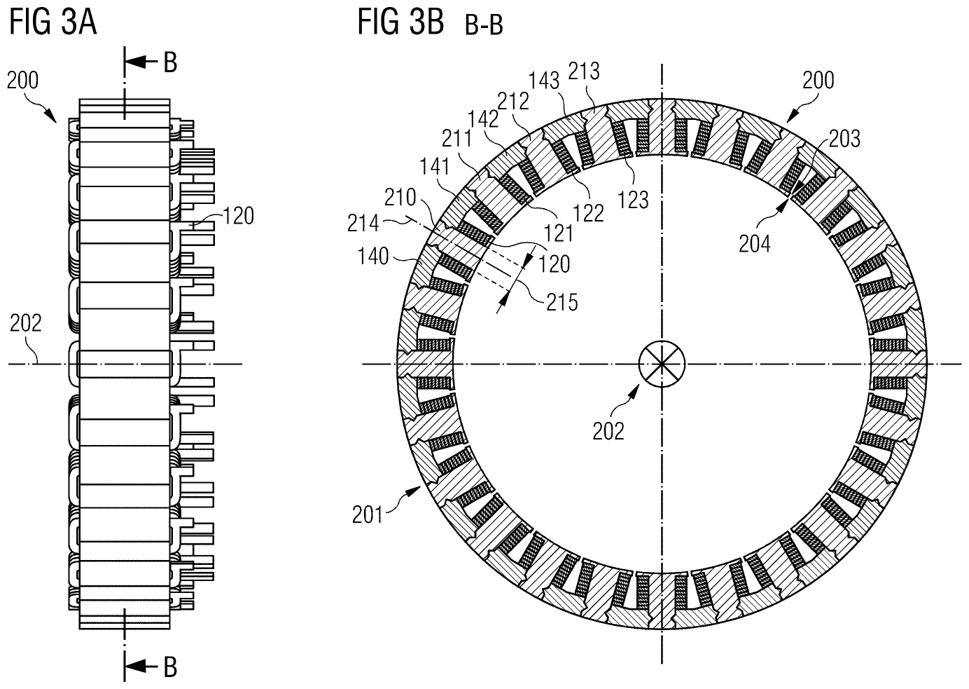

FIG. 4 illustrates a single yoke segment 140-143. Each yoke segment 140-143 connects, optionally removeable, adjacent teeth at the second end of the respective tooth. The stator tooth has a complementary shaped reception for receiving the yoke segment 140-143 by sliding the yoke segment 140-143 into adjacent teeth with a movement parallel to the stator axis 102. A final fixation between the yoke segment 140-143 and the adjacent teeth may be achieved for instance by screws or glue. This aspect is not shown.

At the assembled configuration, each coil is located between the first end and the second end of the respective tooth, wherein the respective tooth is inserted into the coil opening of the respective coil.

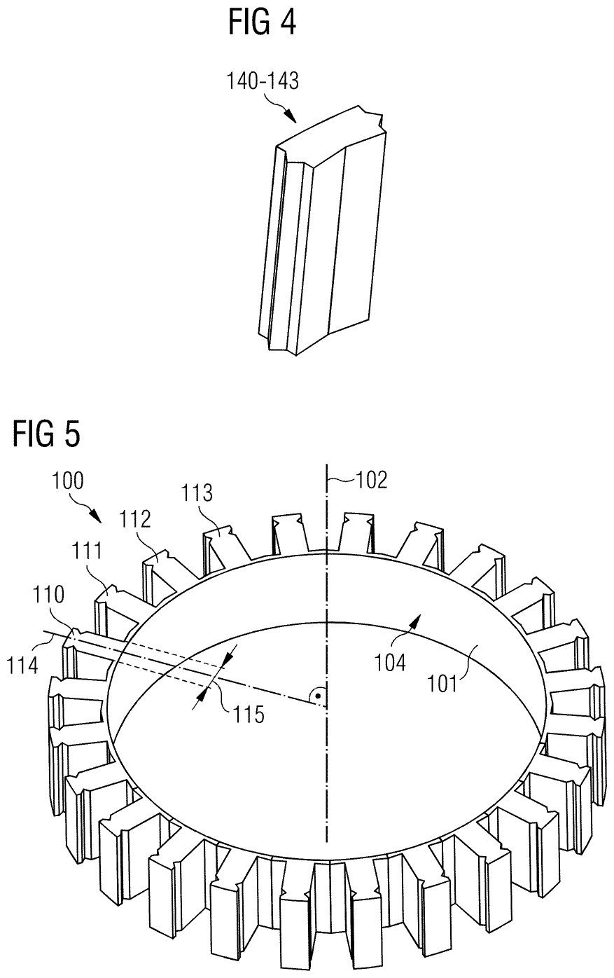

Moreover, in this embodiment the multiplicity of stator teeth constitutes a one-piece part together with the stator ring 101, which is depicted in FIG. 5.

The stator tooth 110 has a tooth width 115, which is which is defined by the dimension of the cross section in the direction orthogonal to the tooth axis 114 and in a plane orthogonal to the stator axis 102, and the longer side 134 of the wire 130 is smaller than the half of the tooth width 115.

In this embodiment each stator tooth 110-113 is joined with the stator ring 101 at the first end. Some embodiments may foresee separate respective parts, which are joinable.

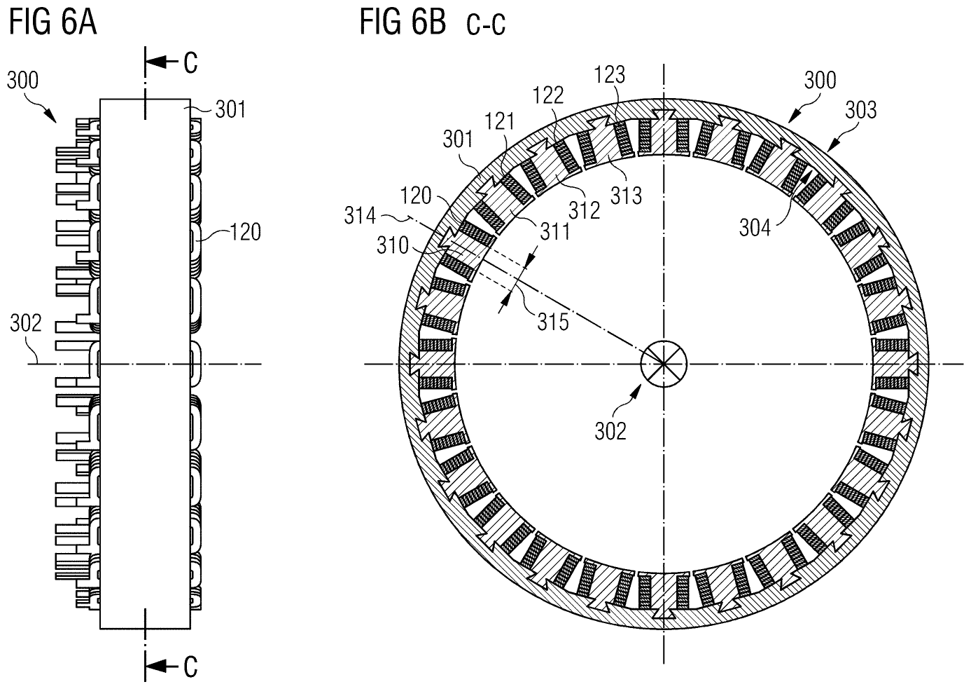

FIGS. 6a to 6c, FIG. 7, and FIG. 8 show a third embodiment with a stator 300 for a permanent magnet synchronous motor.

The stator 300 includes a multiplicity of stator teeth, wherein each stator tooth 310-313 of the multiplicity of stator teeth has a tooth axis 314.

The stator 300 further includes a stator ring 301 with a stator axis 302, wherein the multiplicity of stator teeth is arranged radially along the circumference of the stator ring 301. The tooth axes 314 cross the stator axis 202 orthogonally within one plane.

The stator tooth 310 has a tooth width 315, which is which is defined by the dimension of the cross section in the direction orthogonal to the tooth axis 314 and in a plane orthogonal to the stator axis 302, and the longer side 334 of the wire 330 is smaller than the half of the tooth width 315.

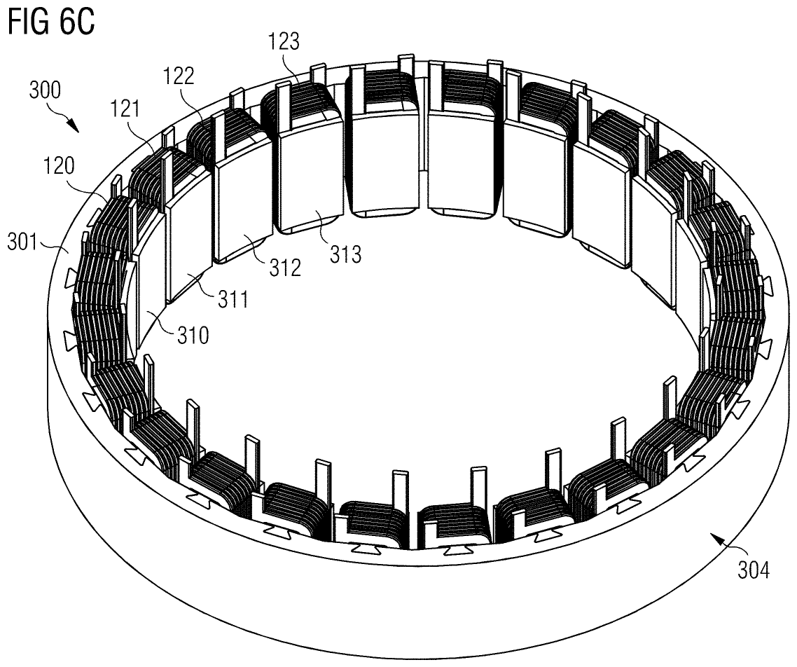

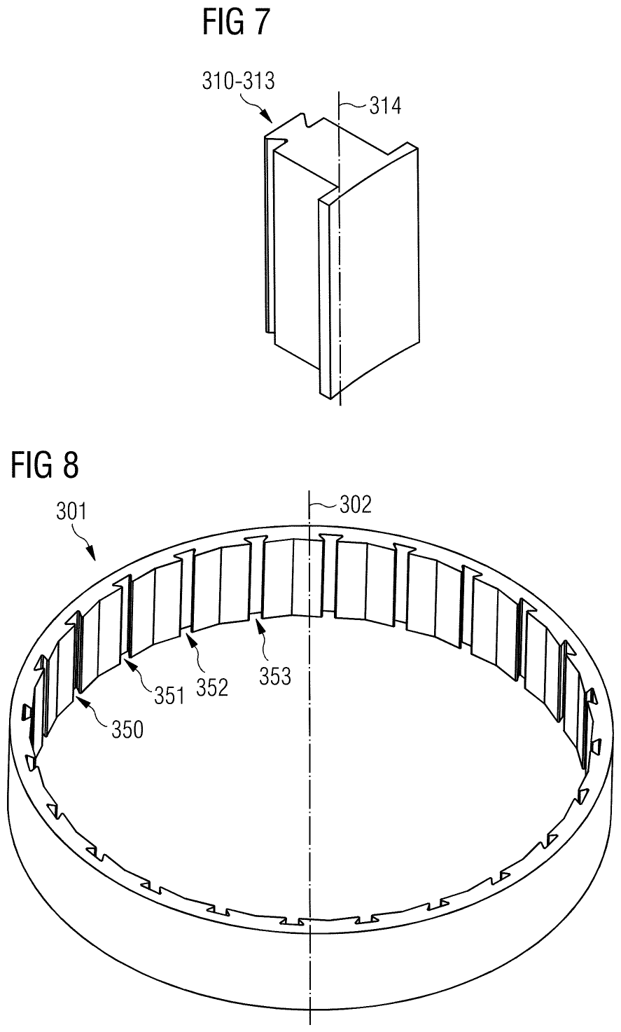

The stator tooth 310-313 is separately shown in FIG. 7 and the stator ring 301 is separately depicted in FIG. 8.

Moreover, the stator 300 includes a multiplicity of stator coils according to the coil shown in FIG. 1, wherein each stator coil 120-123 of the multiplicity of stator coils has a coil axis 124 and a coil opening 125. Each stator coil 120-123 includes windings made of a wire 130, which windings extend along the coil axis 124.

The coil axis 124 of the respective stator coil 120-123 is arranged parallel to the tooth axis 114 of the respective stator tooth 110-113.

The coil opening 125 of the respective stator coil 120-123 surrounds the respective stator tooth 310-313.

The wire 130 of the respective coil 120-123 has a rectangular cross section with a shorter side 133 and a longer side 134, and the shorter side 133 of the wire 130 of the respective coil 120-123 is orientated parallel to the coil axis 124 of the respective stator coil 120-123.

The stator ring 301 includes an inner side 304, directed radially inwards, on which the multiplicity of stator teeth is arranged.

The stator 301 includes a multiplicity of notches, wherein each notch 350-353 of the multiplicity of notches is configured to receive a mounting portion of the respective stator tooth 310-313.

Each notch 350-353 has a longitudinal elongation, which is orientated parallel to the stator axis 302, and has laterally a V-shaped opening, which is configured to receive a complementary shaped mounting portion of the respective stator tooth 310-313.

The stators 100, 200, 300 are well suited for a permanent magnet synchronous motor.

It is advantageous if the stator 100, 200, 300 is used for a permanent magnet synchronous motor, e.g., within or as an electric propulsion system of an aircraft.

The disclosure relates further to a method for assembling the aforesaid stator 100, 200, 300 for a permanent magnet synchronous motor. The acts of the method are not shown in the figures, because they are clear to the skilled person.

An embodiment of the assembly method includes, in act a), providing a stator 100, 200, 300, including a multiplicity of stator teeth, wherein each stator tooth 110-113, 210-213, 310-313 of the multiplicity of stator teeth has a tooth axis 114, 214, 314, and a stator ring 101, 201, 301 with a stator axis 102, 202, 302, wherein the multiplicity of stator teeth is arranged radially along the circumference of the stator ring 101, 201, 301, and the tooth axes 114, 214, 314 cross the stator axis 102, 202, 302 orthogonally within one plane.

The method further includes, in act b), providing a multiplicity of stator coils separately from the multiplicity of stator teeth, wherein each stator coil 120-123 of the multiplicity of stator coils has a coil axis 124 and a coil opening 125 and includes windings made of a wire 130, which windings extend along the coil axis 124, and the wire 130 of the respective coil 120-123 has a rectangular cross section with a shorter side 133 and a longer side 134, and the shorter side 133 of the wire 130 of the respective coil 120-123 is orientated parallel to the coil axis 124 of the respective stator coil 120-123, and providing an insulation layer at least partially on the surface the wire 130 of the respective coil 120-123.

The method further includes, in act c), placing each stator coil on the respective stator tooth 110-113, wherein the coil axis 124 of the respective stator coil 120-123 is arranged parallel to the tooth axis 114, 214, 314 of the respective stator tooth 110-113, 210-213, 310-313 and the coil opening 125 of the respective stator coil 120-123 surrounds the respective stator tooth 110-113.

The method further includes, in act d), assembling the multiplicity of stator teeth, each carrying a respective stator coil 120-123, together with the stator ring 101, 201, 301, if applicable.

The method may be carried out by the sequence of the acts a), b), c), and d). Alternatively, the acts a) and b) or acts c) and d) may also being swapped.

Act d) is only applicable, if the stator ring 101, 201, 301 and the stator teeth 110-113, 210-213, 310-313 are manufactured as separate component, which need to be assembled together. However, in the case that the stator ring 101, 201, 301 and the stator teeth 110-113, 210-213, 310-313 are a one-piece part, act d) is obsolete.

For an embodiment of the method for a stator 100, which shows a closed stator configuration, following acts of the method are illustrated in the figures.

The provision of the stator teeth 110-113 and the stator ring 101 from act a) a one-piece part may be seen in FIG. 2.

The provision of one stator coil 120-123 from act b) may be seen in FIG. 1.

The application or provision of the insulating layer from act b) is not shown in the figures but may be performed for instance by spraying up or immersion of an enamel finish. Alternatively, tape-like insulating layers may be applied between the windings, for example, for high current applications to provide a high insulation resistance.

Placing the stator coils 120-123 on the respective stator tooth 110-113 from act c) results in the configuration shown in FIGS. 2a to 2c.

For an embodiment of the method, which shows a stator configuration with slipped teeth, following acts of the method are illustrated in the figures.

The provision of the stator teeth 310-313 and the stator ring 301 from act a) a one-piece part may be seen in FIG. 7 and FIG. 8.

The provision of one stator coil 120-123 from act b) may be seen in FIG. 1.

The provision of the insulating layer from act b) is not shown in the figures but may be performed by spraying an enamel finish.

Placing the stator coils 120-123 on the stator the respective stator tooth 310-313 from act c) results in the configuration shown in FIGS. 6a to 6b.

A further embodiment of the method for assembling the aforesaid stator, as depicted in FIG. 1 and from FIGS. 2a to 2c, wherein the multiplicity of stator teeth may constitute one piece together with the stator ring 101.

For that matter, the method further includes, (subsequently to the acts a), b), c) and d)),in act e1), providing a multiplicity of yoke segments, wherein each yoke segment 140-143 of the multiplicity of yoke segments is configured to be mounted between two respective adjacent stator teeth 110-113, 210-213 to connect the two respective adjacent stator teeth 110-113, 210-213. The method further includes, in act f1), mounting the yoke segments 140-143 between two respective adjacent stator teeth 110-113, 210-213.

The method of the first further development may be carried out by the sequence of the acts a), b), c), d), e1), and f1). Alternatively, the acts a) and b) or acts c) and d) may also being swapped.

The yoke elements 140-143 are shown in FIG. 4, which are slipped into the corresponding openings parallel to the stator axis 102 or 202. The final assembly is illustrated within FIG. 2b, FIG. 3b and FIG. 6b.

At the first and second embodiment, the stator ring 101, 201 may include an outer side 103, 203, directed radially outwards, on which the multiplicity of stator teeth is arranged.

Another embodiment of the method for assembling the aforesaid stator 300, as depicted in FIG. 1 and from FIGS. 6a to 8, wherein the stator ring 301 includes a multiplicity of notches 350-353, each configured to receive a respective stator tooth 310-313.

Each notches of the multiplicity of notches 350-353 may have a longitudinal elongation, which is orientated parallel to the stator axis 302, and has laterally a V-shaped opening, which is configured to receive a complementary shaped mounting portion of the respective stator tooth 310-313.

For that matter, after act d), the method further includes, in act e2), sliding the stator tooth 310-313 with the stator coil into the notches 350-353.

The method of the second further development may be carried out by sequence of the acts a), b), c), and d). Alternatively, the acts a) and b) or acts c) and d) may also being swapped.

The notches 350-353 are shown in FIG. 8, in which a respective stator tooth 310-313 is slipped into the corresponding opening parallel to the stator axis 302. The final assembly is illustrated within FIG. 6b and FIG. 6c. This configuration leads to a removeable connection between stator teeth 310-313 and the stator ring 301.

A final fixation between the notches 350-353 and the stator teeth 310-313 may be achieved for instance by screws or glue. This aspect is not shown in the figures.

At this embodiment, the stator ring 301 may include an inner side 304, directed radially inwards, on which the multiplicity of stator teeth is arranged.

The disclosure is not restricted to the specific embodiments described in detail herein, but encompasses all variants, combinations, and modifications thereof that fall within the framework of the appended claims.

For example, a stator may include combinations with or without yoke segments or stator teeth on the inner side or on the outer side of the stator ring as well.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE NUMERALS

100, 200, 300 stator
101, 201, 301 stator ring
102, 202, 302 stator axis
103, 203, 303 outer side of the stator ring
104, 204, 304 inner side of the stator ring
110-113, 210-213,
310-313 stator tooth
114, 214, 314 tooth axis
115, 215, 315 tooth width
120-123 stator coil
124 coil axis
125 coil opening
126 coil height
127 coil width
128 coil length
130 rectangular wire
131 wire height
132 wire width
133 shorter side of wire
134 longer side of wire
140-143 yoke segment
350-353 notch

1. A stator for a permanent magnet synchronous motor, the stator comprising:
a multiplicity of stator teeth, wherein each stator tooth of the multiplicity of stator teeth has a tooth axis, and
a stator ring with a stator axis, wherein the multiplicity of stator teeth is arranged radially along a circumference of the stator ring, and the tooth axes of the multiplicity of stator teeth cross the stator axis orthogonally within one plane; and
a multiplicity of stator coils, wherein each stator coil of the multiplicity of stator coils has a coil axis and a coil opening and comprises windings made of a wire, wherein the windings extend along the coil axis, and
wherein the coil axis of a respective stator coil is arranged parallel to the tooth axis of a respective stator tooth and the coil opening of the respective stator coil surrounds the respective stator tooth, and
wherein the wire of the respective stator coil has a rectangular cross section with a shorter side and a longer side, and the shorter side of the wire of the respective stator coil is orientated parallel to the coil axis of the respective stator coil.

2. The stator of claim 1, wherein the respective stator tooth has a tooth width defined by a dimension of the cross section in a direction orthogonal to the tooth axis and in a plane orthogonal to the stator axis, and
wherein the longer side of the wire is smaller than a half of the tooth width.

3. The stator of claim 1, wherein the stator ring comprises an outer side, directed radially outwards, on which the multiplicity of stator teeth is arranged.

4. The stator of claim 1, further comprising:
a multiplicity of yoke segments, wherein each yoke segment of the multiplicity of yoke segments is configured to be mounted between two respective adjacent stator teeth to connect the two respective adjacent stator teeth.

5. The stator of claim 4, wherein the multiplicity of yoke segments and the multiplicity of stator teeth constitute the stator ring.

6. The stator of claim 1, wherein the multiplicity of stator teeth and the stator ring constitute a one-piece part.

7. The stator of claim 1, wherein the stator ring comprises an inner side, directed radially inwards, on which the multiplicity of stator teeth is arranged.

8. The stator of claim 7, wherein the stator ring comprises a multiplicity of notches, and
wherein each notch of the multiplicity of notches is configured to receive a mounting portion of the respective stator tooth.

9. The stator of claim 8, wherein each notch of the multiplicity of notches has a longitudinal elongation, which is orientated parallel to the stator axis, and has laterally a V-shaped opening configured to receive a complementary shaped mounting portion of the respective stator tooth.

10. A permanent magnet synchronous motor comprising:
a stator having:
a multiplicity of stator teeth, wherein each stator tooth of the multiplicity of stator teeth has a tooth axis; and
a stator ring with a stator axis, wherein the multiplicity of stator teeth is arranged radially along a circumference of the stator ring, and the tooth axes of the multiplicity of stator teeth cross the stator axis orthogonally within one plane; and
a multiplicity of stator coils, wherein each stator coil of the multiplicity of stator coils has a coil axis and a coil opening and comprises windings made of a wire, wherein the windings extend along the coil axis, and
wherein the coil axis of a respective stator coil is arranged parallel to the tooth axis of a respective stator tooth and the coil opening of the respective stator coil surrounds the respective stator tooth, and
wherein the wire of the respective stator coil has a rectangular cross section with a shorter side and a longer side, and the shorter side of the wire of the respective stator coil is orientated parallel to the coil axis of the respective stator coil.

11. An aircraft with an electric propulsion system comprising
a permanent magnet synchronous motor having a stator, wherein the stator comprises:
a multiplicity of stator teeth, wherein each stator tooth of the multiplicity of stator teeth has a tooth axis; and
a stator ring with a stator axis, wherein the multiplicity of stator teeth is arranged radially along a circumference of the stator ring, and the tooth axes of the multiplicity of stator teeth cross the stator axis orthogonally within one plane; and
a multiplicity of stator coils, wherein each stator coil of the multiplicity of stator coils has a coil axis and a coil opening and comprises windings made of a wire, wherein the windings extend along the coil axis, and
wherein the coil axis of a respective stator coil is arranged parallel to the tooth axis of a respective stator tooth and the coil opening of the respective stator coil surrounds the respective stator tooth, and
wherein the wire of the respective stator coil has a rectangular cross section with a shorter side and a longer side, and the shorter side of the wire of the respective stator coil is orientated parallel to the coil axis of the respective stator coil.

12. A method for assembling a stator for a permanent magnet synchronous motor, the method comprising:
providing a stator, comprising a multiplicity of stator teeth, wherein each stator tooth of the multiplicity of stator teeth has a tooth axis, and a stator ring with a stator axis, wherein the multiplicity of stator teeth is arranged radially along a circumference of the stator ring, and the tooth axes of the multiplicity of stator teeth cross the stator axis orthogonally within one; and
providing a multiplicity of stator coils separately from the multiplicity of stator teeth, wherein each stator coil of the multiplicity of stator coils has a coil axis and a coil opening and comprises windings made of a wire, wherein the windings extend along the coil axis, and wherein the wire of a respective stator coil has a rectangular cross section with a shorter side and a longer side, and the shorter side of the wire of the respective stator coil is orientated parallel to the coil axis of the respective stator coil;
placing each stator coil on a respective stator tooth, wherein the coil axis of the respective stator coil is arranged parallel to the tooth axis of the respective stator tooth and the coil opening of the respective stator coil surrounds the respective stator tooth; and
assembling the multiplicity of stator teeth, each tooth of the multiplicity of stator teeth carrying a respective stator coil, together with the stator ring, if applicable.

13. The method of claim 12, further comprising:
providing an insulation layer at least partially on a surface the wire of the respective stator coil prior to the placing of each stator coil on the respective stator tooth.

14. The method of claim 13, further comprising:
providing a multiplicity of yoke segments, wherein each yoke segment of the multiplicity of yoke segments is configured to be mounted between two respective adjacent stator teeth to connect the two respective adjacent stator teeth; and
mounting the yoke segments between two respective adjacent stator teeth.

15. The method of claim 14, wherein the stator ring comprises an outer side, directed radially outwards, on which the multiplicity of stator teeth is arranged.

16. The method of claim 12, wherein the stator ring comprises a multiplicity of notches, each notch configured to receive a respective stator tooth, and
wherein each notch of the multiplicity of notches has a longitudinal elongation orientated parallel to the stator axis,
wherein each notch of the multiplicity of notches has laterally a V-shaped opening configured to receive a complementary shaped mounting portion of the respective stator tooth,
wherein the method further comprises, after the assembling of the multiplicity of stator teeth:
sliding the stator tooth with the stator coil into the multiplicity of notches.

17. The method of claim 16, wherein the stator ring comprises an inner side, directed radially inwards, on which the multiplicity of stator teeth is arranged.
